(19) United States
(12) Patent Application Publication
(10) Pub. No.: US 2023/0159366 A1
(43) Pub. Date: May 25, 2023

(54) NOVEL GEOTEXTILE TUBE TYPE SLUDGE DEHYDRATION DEVICE COMBINED WITH VACUUM PRELOADING AND SLUDGE DEHYDRATION METHOD

(71) Applicants: Honglei Sun, Hangzhou City (CN); Zhenqi Weng, Hangzhou City (CN); Wanjie Wang, Hangzhou City (CN)

(72) Inventors: Honglei Sun, Hangzhou City (CN); Zhenqi Weng, Hangzhou City (CN); Wanjie Wang, Hangzhou City (CN)

(73) Assignee: Zhejiang University of Technology, Hangzhou City (CN)

(21) Appl. No.: 18/047,263

(22) Filed: Oct. 17, 2022

(30) Foreign Application Priority Data
Oct. 18, 2021 (CN) 20211 1208 984.9

(51) Int. Cl. C02F 11/121

(52) U.S. Cl. CPC C02F 11/121; C02F 2201/002

(57) ABSTRACT

A novel geotextile tube type sludge dehydration device combined with vacuum preloading including a geotextile tube for filling sludge, a pump drainage mechanism, vacuum tubes and a vacuum pump, where the geotextile tube is divided into top cloth and bottom cloth, a slurry filling inlet is provided on the top cloth, and the top cloth and the bottom cloth are sewn by means of a portable rechargeable bag sewing machine; and the pump drainage mechanism is arranged in the geotextile tube, is connected to the vacuum pump by means of the vacuum tubes, and includes a drainage plate and a hand connector, the drainage plate being inserted into the hand connector, the hand connector is connected to the vacuum tubes, and is fixed by hoops, and the vacuum tubes pass through flange piece ports on the geotextile tube, to be connected to the vacuum pump.

### TECHNICAL FIELD

The present disclosure relates to the technical field of geotextile tubes, and in particular to a novel geotextile tube type sludge dehydration device combined with vacuum preloading. The present disclosure further relates to a sludge dehydration method implemented by using the novel geotextile tube type sludge dehydration device combined with vacuum preloading.

### BACKGROUND ART

A large amount of sludge or slurry will be generated in projects such as river channel dredging, ditch and pond dredging and pile foundation hole excavation, The slurry have high moisture content and are difficult to treat in a short period of time. In traditional treatment, there is a method using a geotextile tube to fill slurry and stacking the slurry to naturally seep drainage. This treatment mode often consumes too long time and has a low site utilization rate. Moreover, the geotextile tube is generally sewn from a high-strength geotextile material, has a cumbersome sewing process, and cannot be reused, resulting in large consumption of a geotextile tube material and high economic cost.

In order to solve the problem that the drainage speed is too low, there is also a treatment mode of placing a drainage plate into a geotextile tube for vacuum preloading and pump drainage, but such a method for treating the geotextile tube has the following problems: 1, the structure is complex, and the drainage plate and a drainage plate fixing mechanism are inconvenient to mount and dismount; 2, the drainage plate and an external pipe fitting are inconvenient to connect, such that it is extremely difficult to solve the connection problem of a plurality of drainage plates in one geotextile tube at a time; and 3, the process of sewing the geotextile tube is tedious, time-consuming and labor-consuming.

### SUMMARY

The technical problem to be solved by the present disclosure is to provide a novel geotextile tube type sludge dehydration device combined with vacuum preloading. A drainage plate in the device is more convenient to mount and dismount.

The technical solution used by the present disclosure is as follows: a novel geotextile tube type sludge dehydration device combined with vacuum preloading includes a geotextile tube for filling sludge, a pump drainage mechanism, vacuum tubes and a vacuum pump, where the geotextile tube is divided into top cloth and bottom cloth, a slurry filling inlet is provided on the top cloth, and the top cloth and the bottom cloth are sewn by means of a portable rechargeable bag sewing machine; and the pump drainage mechanism is arranged in the geotextile tube, is connected to the vacuum pump by means of the vacuum tubes, and includes a drainage plate and a hand connector, the drainage plate being inserted into the hand connector, the hand connector is connected to the vacuum tubes, and is fixed by hoops, and the vacuum tubes pass through flange piece ports on the geotextile tube, to be connected to the vacuum pump.

Preferably, two connecting ropes are arranged on the drainage plate every 2 meters, one ends of the connecting ropes are connected to the drainage plate, and the other ends of the connecting ropes are connected to the bottom cloth of the geotextile tube in a bound manner.

Preferably, the two heads of the drainage plate are tensioned by means of the vacuum tubes, such that the drainage plate is in a horizontal state during treatment.

Preferably, the drainage plate is arranged in a length direction or a height direction of the geotextile tube.

The present disclosure further provides a slurry dehydration method implemented by using the novel geotextile tube type sludge dehydration device combined with vacuum preloading. The slurry dehydration method includes:

1) manufacturing a geotextile tube, using a nut and a bolt to fix a plastic pouring connector in a center of top cloth of the geotextile tube, and repeating operation;

2) manufacturing a vacuum tube inlet, fixing a flange piece on a side edge of lop cloth, to serve as a vacuum tube channel, vacuum tubes being exactly capable of passing through an inner diameter of the flange piece, using a nut and a bolt to fix a vacuum tube inlet/outlet on a side edge close to a short edge direction of the top cloth of the geotextile tube, fixing the flange piece on the side edge of the top cloth, to serve as a vacuum tube channel, and repeating operation;

3) inserting a drainage plate head into the self-closed hand connector, pressing a lower side edge protruding structure, fixing the drainage plate head, inserting the hand connector into a vacuum tube insertion port, using hoops to firmly hoop the vacuum tubes, making the vacuum tubes penetrate the vacuum tube inlet, and connecting the vacuum tubes to the vacuum pump;

4) arranging two connecting ropes on the drainage plate every two meters, connecting the connecting ropes to bottom cloth of the geotextile tube, and tensioning two heads of the drainage plate by means of the vacuum tubes, so as to position the drainage plate;

5) using a portable rechargeable hag sewing machine to overlap edges of the top cloth and the bottom cloth of the geotextile tube for primary sewing, folding sewn edges upwards, sewing the folded edges anew, and repeating work once;

6) filling the geotextile tube with sludge, then switching on a power supply, starting the vacuum pump, applying vacuum loads, then stacking another geotextile tube on the geotextile tube, and starting combined action of vacuum preloading and self-weight consolidation to dehydrate the sludge; and

7) after dehydration is completed, removing the geotextile tube, the vacuum tubes and the vacuum pump, lifting off the top cloth of the geotextile tube, digging out dehydrated sludge, taking the vacuum tubes and the drainage plate out, and cleaning and air-drying the geotextile tube for repeated use.

Preferably, in step 7), after the vacuum tubes and the drainage plate are taken out, the bolt is unscrewed, and the hand connector and the drainage plate are detached for cleaning and air-drying, and then are mounted and used anew.

Compared with the prior art, the present disclosure has the beneficial effects:

1. In the present disclosure, the drainage plate is connected by using the connecting ropes, thin nylon ropes are used as the connecting ropes, and the connecting ropes and the bottom cloth of the geotextile tube are in binding connection, such that mounting and dismounting are convenient, repeated use is facilitated, and quick central positioning of the drainage plate in the geotextile tube is facilitated by the above structure.

2. In the present disclosure, openings of the top cloth and the bottom cloth of the geotextile tube are sewn by using the portable rechargeable bag sewing machine, such that sewing efficiency may be greatly improved.

3. In the present disclosure, the whole drainage mechanism is divided into the geotextile tube and the pump drainage mechanism that may be quickly dismounted and mounted, such that working efficiency is improved favorably, and mounting difficulty is reduced.

### BRIEF DESCRIPTION OF THE DRAWINGS

FIG. 1 is a schematic structural diagram of a novel geotextile tube type sludge dehydration device combined with vacuum preloading provided in Embodiment 1 of the present disclosure.

FIG. 2 is a schematic cross-sectional view of an A-A of FIG. 1.

FIG. 3 is a schematic plan view of a partial structure of a drainage plate in FIG. 1.

FIG. 4 is a schematic structural diagram of a hand connector in FIG. 1.

### DETAILED DESCRIPTION OF THE EMBODIMENTS

The present disclosure will be further described in details below with reference to the accompanying drawings and embodiments. The same parts are designated by the same reference numerals. It should be noted that as used in the following description, the words “front”, “rear”, “left”, “right”, “upper” and “lower” refer to directions in the accompanying drawings, and the words “bottom surface” and “top surface”, “inner” and “outer” refer to directions towards or away from a geometric center of a particular component respectively.

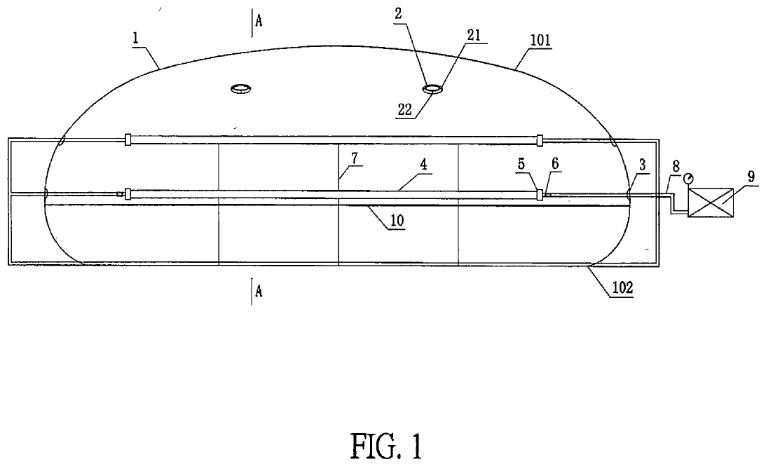

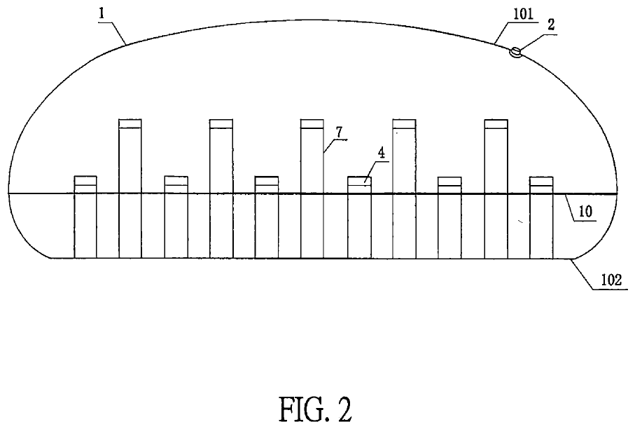

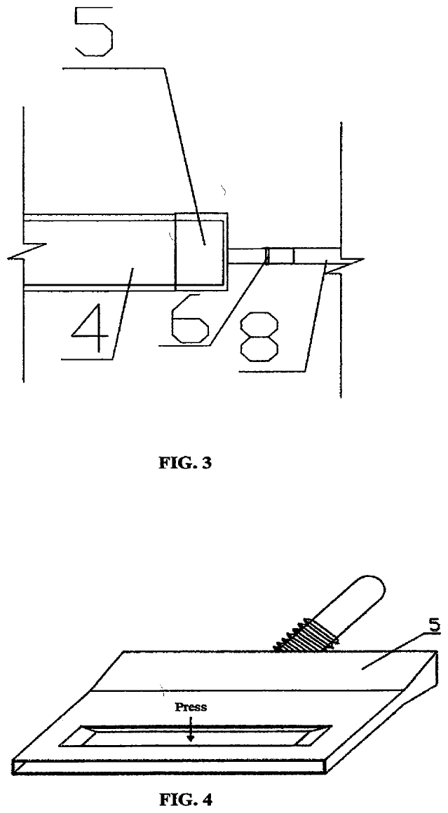

With reference to FIGS. 1-4, a novel geotextile tube type sludge dehydration device combined with vacuum preloading provided in an embodiment of the present disclosure includes a geotextile tube 1 for filling sludge, a pump drainage mechanism, vacuum tubes 8 and a vacuum pump 9, wherein the geotextile tube 1 is divided into top cloth 101 and bottom cloth 102, and the top cloth 101 and the bottom cloth 102 are sewn by means of a portable rechargeable bag sewing machine; a slurry filling inlet 2 is provided on the top cloth 101 of the geotextile tube, and the slurry filling inlet 2 is provided with an open/close switch; the pump drainage mechanism includes a drainage plate 4, a hand connector 5 and connecting ropes 7, the drainage plate 4 being connected to the hand connector 5, a drainage plate 4 head is inserted into the self-closed hand connector 5, it being only necessary to press a lower side edge protruding structure during fixation, the hand connector 5 being in communication with the vacuum pump 9 by means of the vacuum tubes 8, the hand connector 5 and the vacuum tubes 8 being fixed by hoops 6; the vacuum tubes 8 are poly vinyl chloride (PVC) transparent steel wire hoses, the vacuum tubes 8 exactly pass through a flange 3, the vacuum tubes 8 are connected to the hand connector 5 and the vacuum pump 9 for pumping water of sludge filling the zipper type spliced geotextile tube, and joints of the vacuum tubes 8 are tightly hooped and fixed by hoops; the drainage plate 4 is connected to the bottom cloth of the geotextile tube in a bound manner by means of the connecting ropes 7, the two heads of the drainage plate are continuously tensioned during treatment, and the drainage plate may be located in slurry during treatment, so as to prevent the drainage plate from being twisted during use; and the drainage plate is arranged in a length direction or a height direction of the geotextile tube. After the slurry is poured, vacuum loads are applied, the geotextile tube 1 is stacked on the geotextile tube 1, to improve slurry dehydration efficiency.

With reference to FIGS. 1-4, the present disclosure further provides a slurry dehydration method implemented by using the novel geotextile tube type sludge dehydration device combined with vacuum preloading. The slurry dehydration method includes:

1) manufacture a filling inlet 2 of a geotextile tube 1, use a nut and a bolt to fix a plastic pouring connector in a center of top cloth of the geotextile tube, and repeat operation;

2) manufacture a vacuum tube inlet 3, punch a side edge of a short edge direction of top cloth 101 of the geotextile tube, arranging flange piece at a punched position, vacuum tubes being exactly capable of passing through an inner diameter of the flange pipe, a position of a flange piece port corresponding to a position that the vacuum tubes 8 penetrate, and repeat operation;

3) insert a drainage plate 4 into the self-closed hand connector 5, press a lower side edge protruding structure, fix the drainage plate head, screw the hand connector 5 into the vacuum tube 8, use hoops 6 to fix the hand connector 5 and the vacuum tubes 8, make the vacuum tubes 8 penetrate the vacuum tube inlet 3, connect the other ends of the vacuum tubes to the vacuum pump 9, and hoop each joint by a hoop 6;

4) connect the drainage plate 4 to connecting ropes 7, and during construction, continuously tension the vacuum tubes at two heads of the drainage plate, so as to position the drainage plate 4, and prevent the drainage plate from being twisted at the same time;

5) sew a sewn portion 10 of the top cloth and the bottom cloth of the geotextile tube, use a portable rechargeable bag sewing machine to overlap edges of the top cloth and the bottom cloth of the geotextile tube for primary sewing, fold sewn edges upwards, sew the folded edges anew, and repeating work once;

6) fill the geotextile tube 1 with sludge, then switch on a power supply, start the vacuum pump 9, apply vacuum loads, then stack the same geotextile tube 1 on the geotextile tube 1, and start combined action of vacuum preloading and self-weight consolidation to dehydrate the sludge; and

7) after dehydration is completed, detach the sewn portion 10 of the top cloth 101 and the bottom cloth 103, lift off the top cloth 101 of the geotextile tube 1, remove the vacuum tubes 8 and the vacuum pump 9, dig out dehydrated sludge, take the internal pump drainage mechanism out, and clean and air-dry the geotextile tube 1 for repeated use. In step 7), after the internal pump drainage mechanism is taken out, all connecting portions are further needed to be detached, and then are mounted anew.

By means of experimental research on the novel geotextile tube type sludge dehydration device combined with vacuum preloading provided by the present disclosure, the results show that dehydration duration of the novel geotextile tube type sludge dehydration device combined with vacuum preloading of the present disclosure is shortened by 60% compared with a traditional geotextile tube, and water content of slurry is reduced from 160% before an experiment to 40%, thereby greatly improving treatment efficiency.

What is described above is merely the preferred implementation of the present disclosure, the scope of protection of the present disclosure is not limited to the above embodiments, and the technical solutions belonging to the idea of the present disclosure all fall within the scope of protection of the present disclosure. It should be noted that several improvements and modifications made by those of ordinary skill in the art without departing from the principle of the present disclosure should fall within the scope of protection of the present disclosure.

What is claimed is:

1. A novel geotextile tube type sludge dehydration device combined with vacuum preloading, comprising a geotextile tube for filling sludge, a pump drainage mechanism, vacuum tubes and a vacuum pump,
wherein the geotextile tube is divided into top cloth and bottom cloth, and the top cloth and the bottom cloth are sewn by means of a portable rechargeable bag sewing machine; a slurry filling inlet is provided on the top cloth of the geotextile tube, and is provided with an open/close switch; the pump drainage mechanism comprises a drainage plate, a hand connector and connecting ropes, the drainage plate being connected to the bottom cloth of the geotextile tube by means of the connecting ropes such that during treatment, the drainage plate can be located in slurry, to prevent the drainage plate from being twisted during use, the drainage plate being connected to the hand connector, a drainage plate head being inserted into the self-closed hand connector, it being only necessary to press a lower side edge protruding structure during fixation, the hand connector being in communication with the vacuum pump by means of the vacuum tubes, the hand connector and the vacuum tubes being fixed by hoops, and the drainage plate being arranged in a length direction or a height direction of the geotextile tube; and the vacuum tubes are poly vinyl chloride (PVC) transparent steel wire hoses, and are connected to the hand connector and the vacuum pump for pumping water of sludge filling the zipper type spliced geotextile tube, and joints of the vacuum tubes are tightly hooped and fixed by hoops.

2. The novel geotextile tube type sludge dehydration device combined with vacuum preloading according to claim 1, wherein two connecting ropes are arranged on the drainage plate every 2 meters, one ends of the connecting ropes are connected to the drainage plate, and the other ends of the connecting ropes are connected to the bottom cloth of the geotextile tube; the vacuum tubes at two heads of the drainage plate can be freely tensioned during treatment; and the top cloth and the bottom cloth of the geotextile tube are sewn by using the portable rechargeable bag sewing machine.

3. The novel geotextile tube type sludge dehydration device combined with vacuum preloading according to claim 1, wherein the drainage plate is arranged in the length direction or the height direction of the geotextile tube.

4. The novel geotextile tube type sludge dehydration device combined with vacuum preloading according to claim 1, wherein end portions of the connecting ropes can be directly bound on the bottom cloth, such that mounting is convenient.

5. The novel geotextile tube type sludge dehydration device combined with vacuum preloading according to claim 1, wherein the two heads of the drainage plate are tensioned by means of the vacuum tubes, such that the drainage plate is in a horizontal state during treatment.

6. A slurry dehydration method implemented by using the novel geotextile tube type sludge dehydration device combined with vacuum preloading of claim 1, comprising:
1) manufacturing a geotextile tube, using a nut and a bolt to fix a plastic pouring connector in a center of top cloth of the geotextile tube, and repeating operation;
2) manufacturing a vacuum tube inlet, fixing a flange piece on a side edge of top cloth, to serve as a vacuum tube channel, vacuum tubes being exactly capable of passing through an inner diameter of the flange piece, using a nut and a bolt to fix a vacuum tube inlet/outlet on a side edge close to a short edge direction of the top cloth of the geotextile tube, fixing the flange piece on the side edge of the top cloth, to serve as a vacuum tube channel, and repeating operation;
3) inserting a drainage plate head into the self-closed hand connector, pressing a lower side edge protruding structure, fixing the drainage plate head, inserting the hand connector into a vacuum tube insertion port, using hoops to firmly hoop the vacuum tubes, making the vacuum tubes penetrate the vacuum tube inlet, and connecting the vacuum tubes to the vacuum pump;
4) arranging two connecting ropes on the drainage plate every two meters, connecting the connecting ropes to bottom cloth of the geotextile tube, and tensioning two heads of the drainage plate by means of the vacuum tubes, so as to position the drainage plate;
5) using a portable rechargeable bag sewing machine to overlap edges of the top cloth and the bottom cloth of the geotextile tube for primary sewing, folding sewn edges upwards, sewing the folded edges anew, and repeating work once;
6) filling the geotextile tube with sludge, then switching on a power supply, starting the vacuum pump, applying vacuum loads, then stacking another geotextile tube on the geotextile tube, and starting combined action of vacuum preloading and self-weight consolidation to dehydrate the sludge; and
7) after dehydration is completed, removing the geotextile tube, the vacuum tubes and the vacuum pump, lifting off the top cloth of the geotextile tube, digging out dehydrated sludge, taking the vacuum tubes and the drainage plate out, and cleaning and air-drying the geotextile tube for repeated use.

7. The slurry dehydration method implemented by using the novel geotextile tube type sludge dehydration device combined with vacuum preloading according to claim 6, wherein in step 7), after the vacuum tubes and the drainage plate are taken out, the bolt is unscrewed, and the geotextile tube and the drainage plate are detached for cleaning and air-drying, and then are mounted and used anew.
